(19) United States
(12) Patent Application Publication
(10) Pub. No.: US 2023/0130725 A1
(43) Pub. Date: Apr. 27, 2023

(54) SYSTEMS AND METHODS FOR ENCASEMENT OF ADVANCED SEISMIC SENSORS

(71) Applicant: MANDALA INDUSTRIES, LLC, Dover, DE (US)

(72) Inventor: Guillermo Bauer, Buenos Aires (AR)

(21) Appl. No.: 17/512,358

(22) Filed: Oct. 27, 2021

(51) Int. Cl. G01V 1/16

(52) U.S. Cl. CPC G01V 1/162; G01V 2210/1425

(57) ABSTRACT

A system is provided. The system includes a pedestal, a platform, and a sensor enclosure including a housing encompassing one or more sensors. The pedestal is a cuboid oriented in a vertical direction. The platform is a cuboid oriented in a horizontal direction. The sensor enclosure is positioned on a top of and in physical contact with the pedestal. The pedestal is positioned on a top of and in physical contact with the platform. The platform and the sensor enclosure are positioned at distal ends of the pedestal.

### BACKGROUND

The field of the present disclosure relates generally to an encasement for seismic sensors and, more specifically, to the construction and use of encasements for seismic sensors for precise detection of low frequency signals.

Any given object has a natural frequency, where the object resonates or vibrates at its highest amplitude. Seismic sensors are capable of detecting multiple phenomena due to pressure waves and signals at different frequencies, where the signals are transmitted through different materials in the earth from the point of origin to the location of the sensor. However, for many different phenomena the frequencies are difficult to detect and may require precise monitoring of specific frequencies or ranges of frequencies. Furthermore, these frequencies or range of frequencies may change depending on the phenomena to be detected. Furthermore, the readings of precise seismic sensors may change based on the ground and/or soil conditions at the location of the sensor. Accordingly, it would be desirable to have system for protecting and standardizing a precise sensor system that can be used to detect these phenomena.

### BRIEF DESCRIPTION

In one aspect, a system is provided. The system includes a pedestal, a platform, and a sensor enclosure including a housing encompassing one or more sensors. The pedestal is a cuboid oriented in a vertical direction. The platform is a cuboid oriented in a horizontal direction. The sensor enclosure is positioned on a top of and in physical contact with the pedestal. The pedestal is positioned on a top of and in physical contact with the platform. The platform and the sensor enclosure are positioned at distal ends of the pedestal.

In another aspect, an enclosure is provided. The enclosure includes a pedestal shaped as a cuboid oriented in a vertical direction and a platform shaped as a cuboid oriented in a horizontal direction. The pedestal is positioned on a top of and in physical contact with the platform. The enclosure includes a sensor enclosure including a housing encompassing one or more sensors. The sensor enclosure is positioned on a top of and in physical contact with the pedestal. The platform and the sensor enclosure are positioned at distal ends of the pedestal.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawing's arrangements, which are presently discussed, it being understood, however, that the present embodiments are not limited to the precise arrangements and instrumentalities shown, wherein:

FIG. 1 illustrates a block diagram of a system for using precision seismic sensors, in accordance with one embodiment of the present disclosure.

FIG. 2 illustrates an encasement 200 for protecting the precision seismic sensors 115 of the system 100 (shown in FIG. 1).

FIG. 3 illustrates an overhead view of a first configuration of the encasement.

FIG. 4 illustrates an overhead view of a second configuration of the encasement.

FIG. 5 illustrates an example configuration of a user computer device used in the system shown in FIG. 1, in accordance with one example of the present disclosure.

FIG. 6 illustrates an example configuration of a server computer device used in the system shown in FIG. 1, in accordance with one example of the present disclosure.

### DETAILED DESCRIPTION

The implementations described herein relate to seismic sensors and, more specifically, to systems for the construction and use of encasements for seismic sensors for precise detection of low frequency signals. More specifically, a phenomena detecting (“PD”) computer device is provided for monitoring the encased precise seismic sensors and detecting one or more phenomena.

The systems and methods in this disclosure describe an encasement designed to protect and enhance the capabilities of precise seismic sensors used to detect various frequencies underground that indicate the occurrence of different phenomena, including both man-made and natural phenomena. Example phenomena that can be monitored for include, but are not limited to, underground construction, fracking, cave and mine collapse, volcanos, earthquakes, underground nuclear testing, underground digging, underwater movement, building movement and settling, and/or tsunamis.

In this disclosure, a plurality of precise seismic sensors are attuned to a specific phenomenon and are then monitored to detect the occurrence of one or more frequencies that would indicate the occurrence of the specific phenomena. The precise seismic sensors can be attuned to detect phenomena, signals, electromagnetic pulses, pressure waves, sound frequencies, and/or vibration. In the exemplary embodiment, the precise seismic sensors transmit detected signals/frequencies to a connected PD computer device. In some embodiments, the PD computer device transmits samples or portions of the detected signal. The PD computer device analyzes the detected signals/frequencies to determine if there is a match for a fingerprint of the detected phenomena. If the phenomena is detected, the PD computer device can store the information for later use and/or transmit one or more alerts to one or more user devices.

The precise seismic sensors are protected by an encasement that is buried underground to protect the precise seismic sensors, as well as to enhance their detection capabilities. In the exemplary embodiment, the encasement provides a standardized platform for the precise seismic sensors, so that the precise seismic sensors' readings are standardized in different soil and ground conditions.

Described herein are computer systems such as the PD computer devices and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers; reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

The application is flexible and designed to run in various different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the term “low frequencies” refers to frequencies under 100 Hz, especially inaudible frequencies, such as those under 25 Hz.

The systems and processes are not limited to the specific embodiments described herein. In addition, components of each system and each process can be practiced independent and separate from other components and processes described herein. Each component and process also can be used in combination with other assembly packages and processes.

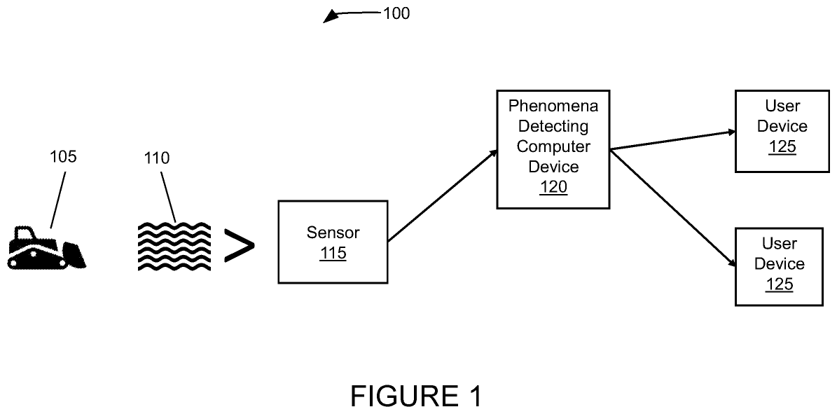

FIG. 1 illustrates a block diagram of a system 100 for using precision seismic sensors 115, in accordance with one embodiment of the present disclosure. In the exemplary embodiment, system 100 is configured to detect one or more phenomena 105 that causes resonance.

For the purpose of this disclosure the phenomena 105 can be either man-made or natural phenomena 105. Examples of phenomena 105 that can be monitored by the system 100 include, but are not limited to, underground construction, fracking, cave and mine strain and/or collapse, volcanos, earthquakes, underground nuclear testing, underground digging, underwater movement, building movement and settling, and/or tsunamis.

The phenomena 105 create signals 110 that travel through the ground and can be detected by precise seismic sensors 115. The signals 110 can include, but are not limited to, electromagnetic pulses, pressure waves, traveling waves, vibrations, sound frequencies, and/or other frequencies. The precise seismic sensors 115 can be attuned to detect phenomena 105. In the exemplary embodiment, the precise seismic sensors 115 are configured to detect a narrow range of frequencies to precisely detect the signals 110 indicative of the occurrence of one or more phenomena 105. The correlation between signals 110 and phenomena 105 can be detected and/or determined through analysis of historical signals 110 detected before, after, and/or during the occurrence of phenomena similar to the one to be detected.

The sensors 115 detect the signals 110 from phenomena 105 and transmit the detection to one or more phenomena detecting (“PD”) computer device 120. In some embodiments, the sensor 115 transmits an indication that the signal 110 has been detected. In other embodiments, the sensor 115 transmits the detected signals 110 for the PD computer device 120 to analyze. In some of these embodiments, the precise seismic sensor 115 is constantly transmitting signals 110 to the PD computer device 120 to analyze.

In some embodiments, the PD computer device 120 is a single computer device. In other embodiments, the PD computer device 120 includes a plurality of computer devices in communication over a network, such as the Internet. In the example embodiment, the PD computer device 120 include a web browser or a software application, which enables the PD computer device 120 to communicate with sensors 115 and one or more user devices 125 using the Internet, a local area network (LAN), or a wide area network (WAN). In some examples, the PD computer device 120 is communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. PD computer devices 120 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In some of these embodiments, there can be a PD computer device 120 at each sensor 115 location, which is then in communication with one or more central or controlling PD computer devices 120.

The PD computer device 120 is further in communication with one or more user devices 125. In the exemplary embodiment, the PD computer device 120 transmits one or more notifications to the one or more user devices 125 when a signal 110 indicative of a phenomena 105 is detected. In the example embodiment, the user devices 125 include a web browser or a software application, which enables the user devices 125 to communicate with the PD computer device 120 using the Internet, a local area network (LAN), or a wide area network (WAN). In some examples, the user devices 125 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem. User devices 125 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

In the exemplary embodiment, when a phenomena 105 occurs, the phenomena 105 causes signals 110 to be transmitted through the Earth or ground. For example, if an earth moving device is being used to dig a hole, then the earth moving device causes vibrations that resonate with the ground surrounding the earth moving device. These vibrations travel through the ground. If attuned to the proper frequencies, as described herein, the precise seismic sensors 115 detect the vibrations.

When the signals 110 from the phenomena 105 reach the sensor 115, the sensor 115 detects the signals 110, which are then transmitted to the PD computer device 120. The PD computer device 120 analyzes the received signals 110 to detect the signal 110 indicative of the phenomena 105. In the exemplary embodiment, the PD computer device 120 filters the received signals 110 to detect the desired signals. In these embodiments, the PD computer device 120 processes the received signals to remove noise and detect the contained frequencies. Then the PD computer device 120 compares the filtered signals 110 to known versions of the signal 110 to determine if the desired signal is present. In some further embodiments, the PD computer device 120 filters the received signals 110 through a bandpass filter to remove unneeded frequencies and noise. In some embodiments, the PD computer device 120 uses fingerprint analysis to detect the appropriate signal 110. In these embodiments, the PD computer device 120 determines if the desired signals 110 are present. If the desired signals 110 are present, the PD computer device 120 can transmit one or more notifications to the user devices 125. For example, if the phenomena 105 is a man-made, such as an earth moving device working underground, the PD computer device 120 can transmit a report with the notification describing when and where the phenomena 105 is occurring to the user devices 125. In another example, if the phenomena 105 is natural, such as a volcano or earthquake, the PD computer device 120 can transmit alerts to user devices 125 for those users to get to safety.

In the exemplary embodiment, the system 100 includes a plurality of sensors 115 at a plurality of locations, wherein at least a portion of the plurality of sensors 115 detects the signals 110. Based on the different locations of the sensors 115, the sensors 115 detect the signals 110 at different times. By comparing the different times that the various sensors 115 detect the signals 110, the PD computer device 120 is capable of determining the location of the phenomena 105 that originated the signals 110.

In the exemplary embodiment, the PD computer device 120 is trained to recognize the desired signals. In some embodiments, this training includes machine learning, where the PD computer device 120 receives a plurality of historical and simulated signals as a training set. The PD computer device 120 uses machine learning to build one or more models based on the training set. The model allows the PD computer device 120 to efficiently and accurately detect the desired signals.

In the exemplary embodiment, the sensors 115 include a precision clock, such as a GPS (global positioning system) clock or atomic clock to accurately track time. This allows the system 100 to accurately and precisely determine when the signals 110 were detected by the sensors 115. The sensors 115 are capable of communicating with the PD computer device 120 using the Internet, a local area network (LAN), or a wide area network (WAN). In some examples, the sensors 115 are communicatively coupled to the Internet through many interfaces including, but not limited to, at least one of a network, such as the Internet, a LAN, a WAN, an integrated services digital network (ISDN), a dial-up-connection, a digital subscriber line (DSL), a cellular phone connection, a satellite connection, and/or a cable modem.

The PD computer device 120 is capable of performing the analysis of the signals 110 in a plurality of different manners. In a first example, the PD computer device 120 is capable of performing statistical analysis on the signals 110. In this example, the PD computer device 120 organizes the signal information into four cases, True Positive, True Negative, False Positive (Type I error), and False Negative (Type II error). The PD computer device 120 defines an allowable gap error between the ends of low possibilities for matching signals 110. An error of just a few seconds could result in a serious mistake in the analysis' efficiency. The PD computer device 120 calculates a confusion matrix (also known as a contingency table). The confusion matrix (or contingency matrix) considers a group with P positive instances and N negative instances of some condition (such as detecting the desired signal 110). The PD computer device 120 formulates the four outcomes into a 2x2 contingency table or confusion matrix.

In a second example, the PD computer device 120 uses a real numbers method to detect the desired signals 110. Assuming x and y are real function values known as Upper [x(t−z)] and Lower [y(z)]. The PD computer device 120 performs correlation simple analysis based on one or more predetermined equations.

In a third example, the PD computer device 120 uses a graphical analysis method to detect the desired signals 110. The graphical analysis method can be performed in at least two methodologies. The first method uses a polar diagram. The second method uses a Cartesian diagram. In the polar diagram method, the signal before calculation and the signal after calculation are compared to the angle from North. The angle from north indicates the angle between the phenomena center and the sensor 115 location with respect to North. The polar diagram method also considers the time between the signal 110 being received and the calculation being performed. In the Cartesian method, the geographic angle from the sensor 115 is not represented. The magnitude of the signal 110 represents the magnitude of the phenomena 105. This is represented on the Cartesian map with a direct correlation between magnitude and dot size.

In some embodiments, the PD computer device 120 performs one or more or all of the above analyses on the received signals 110 to detect the desired signals.

In some embodiments, the PD computer device 120 is in communication with one or more databases (not shown). The database includes a plurality of signal classifications, a plurality of signal information, a plurality of historical signals, a plurality of signal fingerprints, and/or additional information. In some examples, the database is stored remotely from the PD computer device 120. In further examples, the database is decentralized. In at least one example, a person can access the database via the user device 125 by logging onto the PD computer device 120.

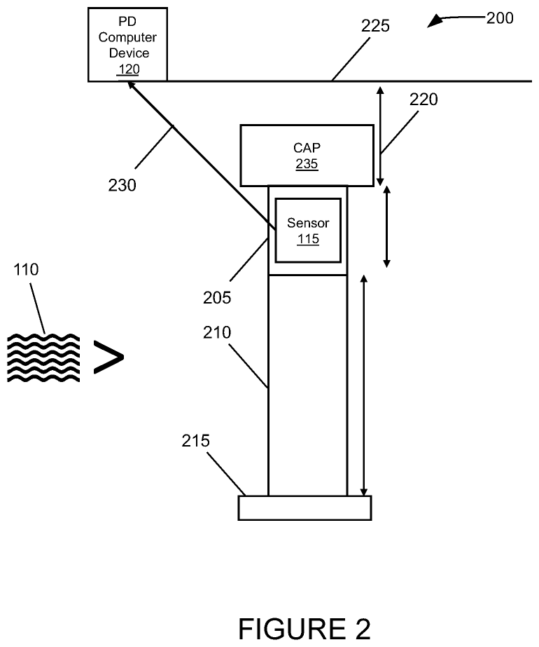

FIG. 2 illustrates an encasement 200 for protecting the precision seismic sensors 115 of the system 100 (shown in FIG. 1). Signals 110 (shown in FIG. 1) may react to different materials that the signals 110 pass through. Furthermore, the surrounding materials and placement of the precision seismic sensors 115 can affect the readings made by said precision seismic sensors 115. While this effect can be counteracted by the PD computer device 120, this counteraction requires attunement. Therefore, the herein described encasement 200 protects the sensitive sensor 115 as well as provides a stable, standardized base for the precision seismic sensors 115.

Furthermore, a standardized base, such as encasement 200, can provide a standardized effect on the signal 110 as it is being detected. Accordingly, it is easier for the PD computer device 125 to account for the effect of the encasement 200 when the encasements 200 are standardized.

In the exemplary embodiment, the sensors 115 are placed in a sealed enclosure 205. The enclosure 205 may be built of a variety of different materials, including metal and various plastics. The enclosure 205 is designed to be sealed so that moisture does not leak in and potentially affect the sensors 115. The enclosure 205 is place on a pedestal 210. The pedestal 210 provides a secure base for the sensors 115 and enclosure 205. The pedestal 210 rests on a platform 215. The platform 210 provides a stable base for the pedestal 210.

In different embodiments, the enclosure 205 can be a cube or cuboid with a square base or the enclosure 205 can also be a cylinder. In at least one example, the enclosure is 60 centimeters on a side at the base. In another example, the enclosure is 60 centimeters in diameter. The size of the enclosure 205 may vary based on the requirements of the sensors 115.

In the exemplary embodiment, the pedestal 210 is constructed of concrete or reinforced concrete, such as with rebar. The top of the pedestal 210 extends past the enclosure 205 for one to two centimeters to provide a stable base for the enclosure 205. The pedestal 210 can be a cylinder or cuboid depending on conditions and the shape of the enclosure 205. In the exemplary embodiment, the pedestal 210 is two to three meters in height. In other embodiments, the pedestal 210 can range in height from one to ten meters based on the surrounding conditions and other variables. For example, the pedestal 210 may be taller in areas where the ground is sandy rather than in areas where the ground is clay.

In the exemplary embodiment, the enclosure 205 is centered atop the pedestal 210. The pedestal 210 is further centered atop the platform 215.

In the exemplary embodiment, the platform 215 is constructed of concrete reinforced, such as with rebar. The platform 215 is a four-meters square slab. The platform 215 can range in size up to ten-meters square based on conditions. The platform 215 can range in height from 10 centimeters to 20 centimeters, based on conditions and the size of the pedestal 210.

The above sizes of the enclosure 205, the pedestal 210, and the platform 215 can change based on the intended use of the sensors 115, such as, but not limited to, what the sensors 115 are intended to detect, what are the local soil conditions, and what are the soil conditions and the phenomena 105 to be the detected.

The enclosure 205, the pedestal 210, and the platform 215 are buried a specific distance 220 underground 225. The distance 220 can vary based on local conditions. In the exemplary embodiment, the distance 220 from the ground 225 to the top of the enclosure is between two and three meters. In the exemplary embodiment, the combination of the enclosure 205, the pedestal 210, and the platform 215 amplifies the signal 110 and improves the sensitivity of the sensors 115. In some embodiments the pedestal 210 and the platform 215 act as an antenna for the sensors 115 by increasing the surface area of the encasement 200 that receives the signals

In some embodiments, the sensors 115 are in communication with the PD computer device 120 via a wired connection 230. In other embodiments, the sensors 115 are in communication with the PD computer device 120 via a wireless connection 230. In other embodiments, the sensor 115 is in communication with one or more computer devices that are then in communication with the PD computer device 120, wherein the one or more computer devices forward sensor information and/or other information to the PD computer device 120 to allow it to act as described herein.

In some further embodiments, a cap 235 is placed on top of the enclosure 205 to secure the sensors 115 and prevent tampering. In these embodiments, cap 235 could be 1-2 meters in height and be wider than the enclosure 205 to surround the enclosure 205. This prevents tampering with the sensor 115 by both humans and animals and protects the enclosure 205 and sensors 115 from environmental factors. In these embodiments, the cap 235 is put into place when the sensor 115 is fully tuned and ready to be deployed.

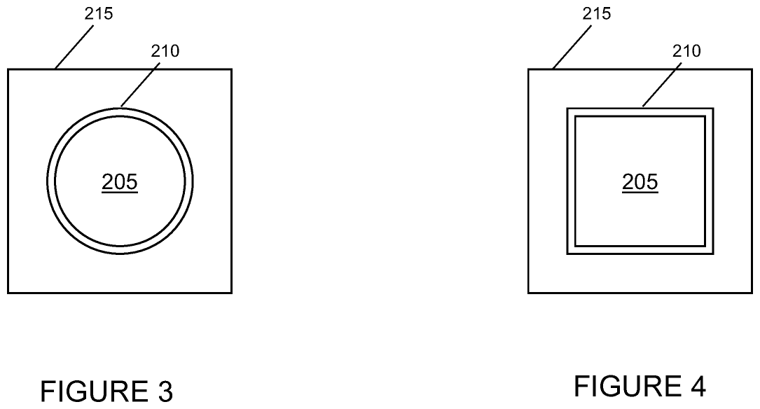

FIG. 3 illustrates an overhead view of a first configuration of the encasement 200 (shown in FIG. 2). In FIG. 3, the enclosure 205 and the pedestal 210 are both cylindrical where the top of the pedestal 210 where the enclosure 205 is positioned is slightly larger than the base of the enclosure 205. In FIG. 3, the cap 235 (shown in FIG. 2) is not shown to for clarity purposes. As shown in FIG. 3, the enclosure 205 is centered atop the pedestal 210. The pedestal 210 is further centered atop the platform 215.

FIG. 4 illustrates an overhead view of a second configuration of the encasement 200 (shown in FIG. 2). In FIG. 3, the enclosure 205 and the pedestal 210 are both cuboid where the top of the pedestal 210 where the enclosure 205 is positioned is slightly larger than the base of the enclosure 205. In FIG. 4, the cap 235 (shown in FIG. 2) is not shown to for clarity purposes. As shown in FIG. 4, the enclosure 205 is centered atop the pedestal 210. The pedestal 210 is further centered atop the platform 215.

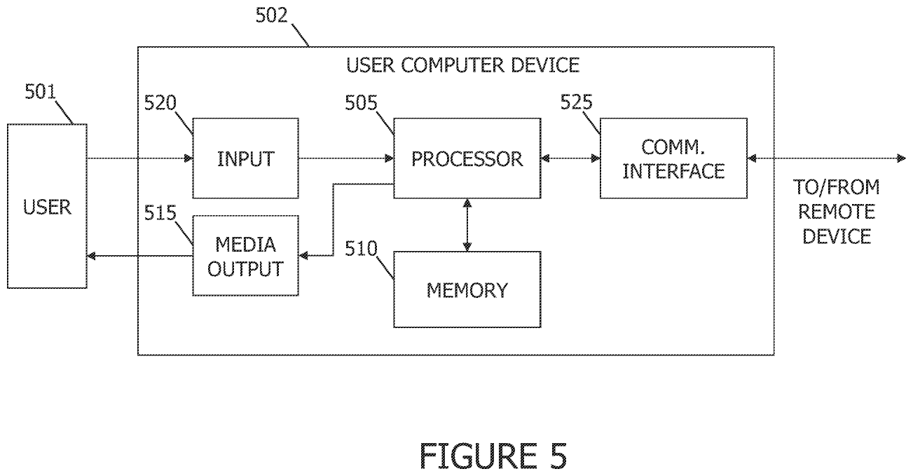

FIG. 5 illustrates an example configuration of a user computer device 502 used in the system 100 (shown in FIG. 1), in accordance with one example of the present disclosure. User computer device 502 is operated by a user 501. The user computer device 502 can include, but is not limited to, user device 125 (shown in FIG. 1). The user computer device 502 includes a processor 505 for executing instructions. In some examples, executable instructions are stored in a memory area 510. The processor 505 can include one or more processing units (e.g., in a multi-core configuration). The memory area 510 is any device allowing information such as executable instructions and/or transaction data to be stored and retrieved. The memory area 510 can include one or more computer-readable media.

The user computer device 502 also includes at least one media output component 515 for presenting information to the user 501. The media output component 515 is any component capable of conveying information to the user 501. In some examples, the media output component 515 includes an output adapter (not shown) such as a video adapter and/or an audio adapter. An output adapter is operatively coupled to the processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some examples, the media output component 515 is configured to present a graphical user interface (e.g., a web browser and/or a client application) to the user 501. A graphical user interface can include, for example, an interface for viewing the information about the detected phenomena 105 (shown in FIG. 1). In some examples, the user computer device 502 includes an input device 520 for receiving input from the user 501. The user 501 can use the input device 520 to, without limitation, select a sensor 115 (shown in FIG. 1) to view. The input device 520 can include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen can function as both an output device of the media output component 515 and the input device 520.

The user computer device 502 can also include a communication interface 525, communicatively coupled to a remote device such as the PD computer device 120 (shown in FIG. 1). The communication interface 525 can include, for example, a wired or wireless network adapter and/or a wireless data transceiver for use with a mobile telecommunications network.

Stored in the memory area 510 are, for example, computer-readable instructions for providing a user interface to the user 501 via the media output component 515 and, optionally, receiving and processing input from the input device 520. A user interface can include, among other possibilities, a web browser and/or a client application. Web browsers enable users, such as the user 501, to display and interact with media and other information typically embedded on a web page or a website from the PD computer device 120. For example, instructions can be stored by a cloud service, and the output of the execution of the instructions sent to the media output component 515.

The processor 505 executes computer-executable instructions for implementing aspects of the disclosure.

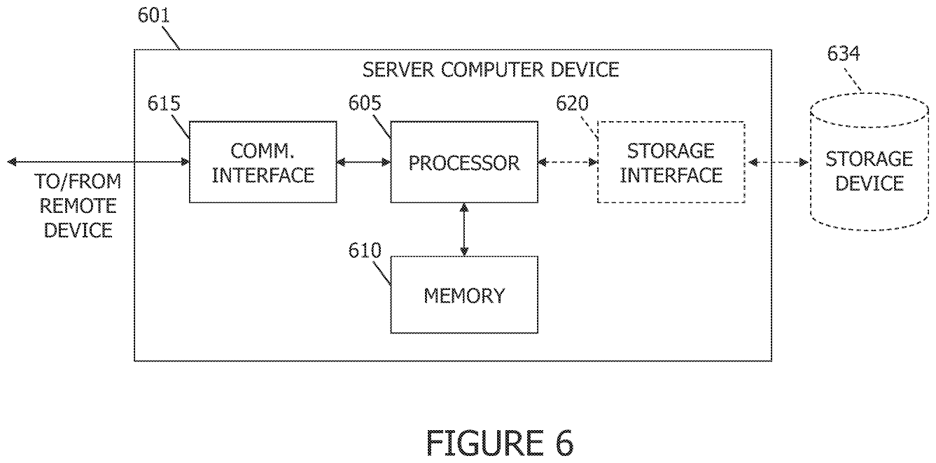

FIG. 6 illustrates an example configuration of a server computer device 601 used in the system 100 (shown in FIG. 1), in accordance with one example of the present disclosure. Server computer device 601 can include, but is not limited to, the PD computer device 120 (shown in FIG. 1). The server computer device 601 also includes a processor 605 for executing instructions. Instructions can be stored in a memory area 610. The processor 605 can include one or more processing units (e.g., in a multi-core configuration).

The processor 605 is operatively coupled to a communication interface 615 such that the server computer device 601 is capable of communicating with a remote device such as another server computer device 601, another PD computer device 120, or one or more user devices 125 (shown in FIG. 1). For example, the communication interface 615 can receive requests from the user device 125 via the Internet, as illustrated in FIG. 1.

The processor 605 can also be operatively coupled to a storage device 634. The storage device 634 is any computer-operated hardware suitable for storing and/or retrieving data, such as, but not limited to, data associated with the database. In some examples, the storage device 634 is integrated in the server computer device 601. For example, the server computer device 601 can include one or more hard disk drives as the storage device 634. In other examples, the storage device 634 is external to the server computer device 601 and can be accessed by a plurality of server computer devices 601. For example, the storage device 634 can include a storage area network (SAN), a network attached storage (NAS) system, and/or multiple storage units such as hard disks and/or solid-state disks in a redundant array of inexpensive disks (RAID) configuration.

In some examples, the processor 605 is operatively coupled to the storage device 634 via a storage interface 620. The storage interface 620 is any component capable of providing the processor 605 with access to the storage device 634. The storage interface 620 can include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 605 with access to the storage device 634.

The processor 605 executes computer-executable instructions for implementing aspects of the disclosure. In some examples, the processor 605 is transformed into a special purpose microprocessor by executing computer-executable instructions or by otherwise being programmed.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, and telematics data. ML outputs may include but are not limited to: digital signals (e.g. information data converted from natural phenomena). ML outputs may further include: speech recognition, image or video recognition, medical diagnoses, statistical or financial models, processed signals, signal recognition and identification, autonomous vehicle decision-making models, robotics behavior modeling, signal detection, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with different signals received and their corresponding classifications, generate a model which maps the signal data to the classification data, and recognize future signals and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data comprising event data, financial data, social data, geographic data, cultural data, signal data, and political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein may include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a pedestal;
a platform; and
a sensor enclosure including a housing encompassing one or more sensors, wherein the pedestal is a cuboid oriented in a vertical direction, wherein the platform is a cuboid oriented in a horizontal direction, wherein the sensor enclosure is positioned on a top of and in physical contact with the pedestal, wherein the pedestal is positioned on a top of and in physical contact with the platform, and wherein the platform and the sensor enclosure are positioned at distal ends of the pedestal.

2. The system of claim 1, wherein the platform is positioned perpendicular to the pedestal.

3. The system of claim 1, wherein the platform is constructed of reinforced concrete.

4. The system of claim 1, wherein the pedestal is constructed of reinforced concrete.

5. The system of claim 1, wherein the system is buried underground, such that the sensor enclosure is two meters or more underground.

6. The system of claim 1 further comprising a cap positioned on top of the sensor enclosure.

7. The system of claim 6, wherein the cap is constructed of concrete.

8. The system of claim 6, wherein the cap is at least one meter thick.

9. The system of claim 1, wherein the one or more sensors are precise seismic sensors.

10. The system of claim 1, wherein the one or more sensors are in communication with at least one computer device positioned above ground.

11. An enclosure comprising:
a pedestal shaped as a cuboid oriented in a vertical direction;
a platform shaped as a cuboid oriented in a horizontal direction, wherein the pedestal is positioned on a top of and in physical contact with the platform; and
a sensor enclosure including a housing encompassing one or more sensors, wherein the sensor enclosure is positioned on a top of and in physical contact with the pedestal, and wherein the platform and the sensor enclosure are positioned at distal ends of the pedestal.

12. The enclosure of claim 11, wherein the platform is positioned perpendicular to the pedestal.

13. The enclosure of claim 11, wherein the platform is constructed of reinforced concrete.

14. The enclosure of claim 11, wherein the pedestal is constructed of reinforced concrete.

15. The enclosure of claim 11, wherein the enclosure is buried underground, such that the sensor enclosure is two meters or more underground.

16. The enclosure of claim 11 further comprising a cap positioned on top of the sensor enclosure.

17. The enclosure of claim 16, wherein the cap is constructed of concrete.

18. The enclosure of claim 16, wherein the cap is at least one meter thick.

19. The enclosure of claim 11, wherein the one or more sensors are precise seismic sensors.

20. The enclosure of claim 11, wherein the one or more sensors are in communication with at least one computer device positioned above ground.
